(19) United States
(12) Patent Application Publication
(10) Pub. No.: US 2005/0221890 A1
(43) Pub. Date: Oct. 6, 2005

(54) Method and system for monitoring and displaying positions of competing moving objects

(76) Inventors: Aron Schatten, Delray (US); Rachel Schatten, New York, NY (US)

Correspondence Address: SCHULTE ROTH & ZABEL LLP;ATTN: JOEL E. LUTZKER, 919 THIRD AVENUE, NEW YORK, NY, 10022, US

(21) Appl. No.: 10/815,373

(22) Filed: Apr. 1, 2004

(51) Int. Cl. A63F 13/00

(52) U.S. Cl. 463/30

(57) ABSTRACT

A method and system for monitoring and displaying positions of competing moving objects, including a unique identifier placed onto each competing moving object, an identifier detector, a processor and a display. The identifier uniquely identifies a position of each competing moving object at any moment of time. The detector detects positions of the unique identifier and conveys the detected positions to the processor. The processor determines relative positions of the competing moving objects using the information received from the detector and transmits these positions to the display for displaying to observers.

### BACKGROUND OF THE INVENTION

The present invention relates to monitoring and displaying a plurality of moving objects. In particular, it relates to methods and system for monitoring and displaying the relative positions of competitors to the viewers.

Currently there is an ever growing public desire for more detailed analytical and/or pictorially represented information regarding sporting events.

In horse racing, for example, it has been desired to have information about a relative positioning of horses with respect to each other at any given moment in time. Until now, these relative positions were determined by continuously calculating the speed of a horse as it moves around a racetrack. For example, the speed has been calculated by sectional timing over substantial track lengths. Sectional timing involves the calculation of average speed by recording the distance between two fixed points, and the time taken to cover that distance. Because of the length of sections over which timing has taken place this type of timing system may be misleading.

An alternative method of determining the speed of a plurality of competitors is discussed in U.S. Pub. No. US2002/0198612A1. The '612 Publication discloses a system where horses in a horserace for which speed and/or positional location data is desired are monitored by having each of these horses carry a position locating device which performs location determinations at closely spaced time intervals. The data produced by these devices is then used to determine and display the speed and/or position of these horses, the speed being the speed of travel between location measurements and the positions corresponding to the location measurements. However, the '612 Publication does not teach determining or displaying relative positions of competing moving objects with respect to each other.

### BRIEF SUMMARY

According to one aspect of the present invention, a method of monitoring a plurality of competitors in a sporting event is provided, the method comprising the steps of:

uniquely identifying a position of each competing moving object at any moment of time by a unique identifier placed onto said each competing moving object;

detecting positions of said unique identifier;

conveying said detected positions of said unique identifier to a processor;

determining relative positions of said competing moving objects using said processor;

transmitting said determined relative positions to a display; and

displaying said relative positions of said competing moving objects to observers.

According to another aspect of the present invention a system for monitoring and displaying positions of competing moving objects is provided by the invention. The system generally includes a unique identifier placed onto each competing moving object, an identifier detector, a processor and a display. The identifier uniquely identifies a position of each competing moving object at any moment of time. The detector detects positions of the unique identifier and conveys the detected positions to the processor. The processor determines relative positions of the competing moving objects using the information received from the detector and transmits these positions to the display for displaying to observers.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is a schematic diagram of the system of the present invention in accordance with the first embodiment; and

FIG. 2 is a schematic diagram of the system of the present invention in accordance with the second embodiment.

### DETAILED DESCRIPTION OF THE DRAWINGS

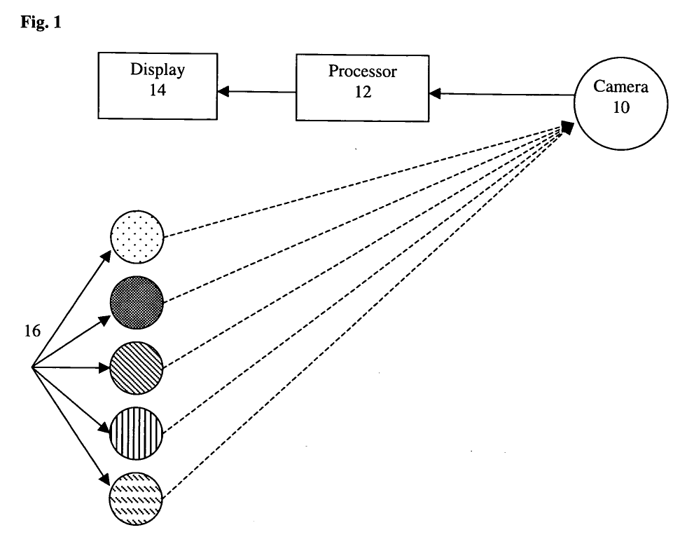

As shown in FIG. 1 and in accordance with the first embodiment of the present invention, the system for displaying and monitoring positions of competitors in a sporting event preferably includes a camera 10, a processor 12 and a display 14. In accordance with this preferred embodiment, each competitor is provided with an easily identifiable and unique visual pattern 16. Although shown in FIG. 1 as a geometric pattern, visual pattern 16 can include colors, numbers, letters, infrared markings or any other identifiable pattern. Camera 10 tracks the visual pattern 16 provided on each competitor and conveys the tracking information, preferably in the form of relative positioning of digital images, to the processor 12.

Processor 12 is preferably provided with a pattern recognition software. When the tracking information is received by the processor 12, the pattern recognition software translates the images into respective competitors' positions. Thus, when processor 12 receives a number of digital images corresponding to the same number of competitors, the processor will identify the competitors from their corresponding digital images and will extrapolate the positions of these competitors relative to each other. Although FIG. 1 shows processor 12 as being a separate device from the camera 10, they may be formed as a single device incorporating both elements.

Processor 12 transmits the extrapolated positions of identified competitors onto one or multiple displays 14. Relative positions of the competitors are then displayed to the viewers such that these positions can be easily distinguished by the observers. For this purpose, processor 12 may multiply distances between competitors by a certain equal multiplier so that these distances appear larger on the display. This multiplier is selected by the processor 12 based at least partially on the actual distances between competitors and the size factor of the display. The processor may also select an appropriate advertisement to be displayed on the display 14 simultaneously with displaying the competitors' positions. The appropriate advertisement may be selected from a plurality of advertisement messages preliminarily stored and identified by the processor 12.

Please note that display 14 can be a TV display, a computer monitor, a PDA display or any other device capable of displaying graphical or image information.

The above embodiment of the invention can be illustrated using a horse race example. Each horse will be provided with the visual identifier pattern 16. Continuously, during the race, camera 10 will track the visual pattern of each horse and its relative position to visual patterns of other horses and will transmit this information to the processor 12. Processor 12 will identify competitors and their relative positioned based on the received visual patterns and will transmit these positions to the display 14 for showing to the viewers. Thus, at any given moment of the race, viewers will be able to clearly identify the leader in the race and relative positions of all horses.

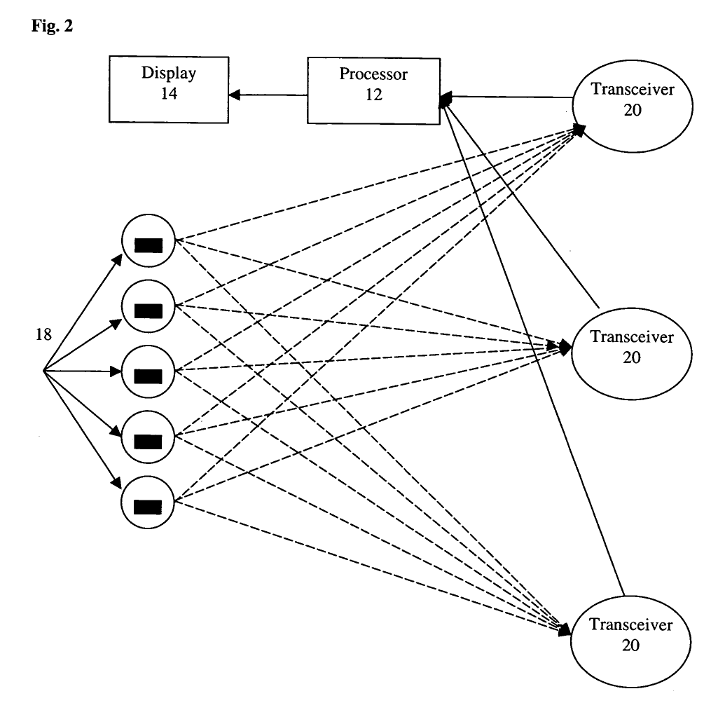

An alternative embodiment of the present invention is shown in FIG. 2. In the alternative embodiment, each competitor is identified by a unique chip 18 producing electromagnetic signals. Multiple signal transceivers 20 are strategically placed around the place of competition such that a position of each competitor can be precisely derived from the source of the electro-magnetic signal. Each transceivers 20, from its unique point of view, identifies the source of electro-magnetic radiation from each chip 18 and transmits this information to the processor 12. In the preferred alternative embodiment, a method of triangulation is used to determine the position of each competitor. This triangulation is preferably performed by the processor 12, which receives information from transceivers 20. The determined relative positions of the competitors are then transmitted to the display 14 in the manner similar to that described above with respect to the first preferred embodiment.

Alternative equivalent technologies, for example, GPS system, cell tower system, etc., can be utilized with the present invention.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

1. A system for monitoring and displaying positions of competing moving objects, comprising:
a unique identifier placed onto each competing moving object, said identifier being configured to uniquely identify a position of said each competing moving object at any moment of time;
an identifier detection means, said detection means being configured to detect positions of said unique identifier;
a processor; and
a display,
wherein said identifier detection means conveys said detected positions of said unique identifier to said processor; wherein said processor determines relative positions of said competing moving objects; and wherein said processor transmits said determined relative positions to said display for displaying to observers.

2. The system according to claim 1, wherein said unique identifier is a visual pattern and wherein said identifier detection means is a camera.

3. The system according to claim 2, wherein said visual pattern comprises an identifiable color.

4. The system according to claim 2, wherein said camera detects said visual pattern of each competing moving object and its position relative to said visual patterns of other competing moving objects.

5. The system according to claim 4, wherein said camera conveys said detected visual pattern and said relative position to said processor, and wherein said processor identifies said each competing moving object using said detected visual pattern and determines relative positions of said competing moving objects.

6. The system according to claim 5, wherein said processor further comprises a visual pattern recognition software.

7. The system according to claim 1, wherein said unique identifier is a chip generating electro-magnetic signals and wherein said identifier detection means is a plurality of transceivers receiving said electromagnetic signals from said chip.

8. The system according to claim 7, wherein said processor determines said relative position of said competing moving objects based on the information received from said plurality of transceivers.

9. The system according to claim 8, wherein said processor further comprises triangulation software.

10. A method of monitoring and displaying positions of competing moving objects, comprising the steps of:
uniquely identifying a position of each competing moving object at any moment of time by a unique identifier placed onto said each competing moving object;
detecting positions of said unique identifier;
conveying said detected positions of said unique identifier to a processor;
determining relative positions of said competing moving objects using said processor;
transmitting said determined relative positions to a display; and
displaying said relative positions of said competing moving objects to observers.

11. The method according to claim 10, wherein said step of detecting positions of said unique identifier further comprises the step of detecting a visual pattern associated with said each competing moving object.

12. The method according to claim 11, wherein said step of determining relative positions of said competing moving objects using said processor further comprises the step of recognizing said visual pattern using a pattern recognition software.

13. The method according to claim 10, wherein said step of detecting positions of said unique identifier further comprises the step of detecting an electro-magnetic signal produced by a chip associated with said each competing moving object.

14. The method according to claim 13, wherein said step of determining relative positions of said competing moving objects using said processor further comprises the step of triangulating a plurality of said electromagnetic signals.
